(19) United States
(12) Patent Application Publication
(10) Pub. No.: US 2021/0170946 A1
(43) Pub. Date: Jun. 10, 2021

(54) VEHICLE SURROUNDING IMAGE DISPLAY DEVICE

(71) Applicant: TOYOTA JIDOSHA KABUSHIKI KAISHA, Toyota-shi (JP)

(72) Inventors: Tomoyuki YOSHIDA, Nisshin-shi (JP); Tomohito HIGUMA, Toyota-shi (JP)

(21) Appl. No.: 17/086,747

(22) Filed: Nov. 2, 2020

(30) Foreign Application Priority Data
Dec. 10, 2019 (JP) 2019-223069

(51) Int. Cl. B60R 1/00; H04N 5/262; H04N 5/445; H04N 5/272

(52) U.S. Cl. CPC B60R 1/00; H04N 5/2628; H04N 5/445; B60R 2300/30; B60R 2300/20; B60R 2300/10; H04N 5/272

(57) ABSTRACT

A vehicle surrounding image display device includes a display control unit configured to cause an image display unit to display a first image which is one of captured images behind a vehicle and an area behind and to sides of the vehicle and corresponding in a specific area, the specific area being an area within a range of a first length extending in both directions outward from a horizontal central part of a display area of the image display unit and within a range of a second length extending vertically downward from an upper end of the display area; and display a second image which is one of the captured images and corresponding to the area outside of the specific area in an area outside of the specific area of the display area, the second image being compressed higher than the first image.

### CROSS-REFERENCE TO RELATED APPLICATION

This application claims priority to Japanese Patent Application No. 2019-223069 filed on Dec. 10, 2019, incorporated herein by reference in its entirety.

### BACKGROUND

### 1. Technical Field

The present disclosure relates to a vehicle surrounding image display device.

### 2. Description of Related Art

The technique described in Japanese Unexamined Patent Application Publication No. 2012-170127 (JP 2012-170127 A) displays the video behind the vehicle in the horizontal central display area of the video display means at a video size corresponding to the image reflected on the inner mirror. At the same time, this technique displays the video behind and to the right of the vehicle and the video behind and to the left of the vehicle in the display areas outside of the central display area as an image compressed higher than the video behind the vehicle.

### SUMMARY

For an object that is located at a predetermined distance or more from the vehicle, the display size of the object on the display image has a large effect on the feeling of a sense of distance to the object. On the other hand, for an object that is within a predetermined distance from the vehicle, the relative position between the vehicle and the object on the display image has a large effect on the feeling of a sense of distance to the object. The technique described in JP 2012-170127 A does not treat the feeling of a sense of distance to an object but only switches the display between the central display area and the outer display area regardless of the distance between the vehicle and an object. Therefore, there is room for improvement in allowing an occupant of the vehicle to feel a correct sense of distance between the vehicle and an object from the displayed image.

The present disclosure provides a vehicle surrounding image display device that allows an occupant to feel a correct sense of distance to an object existing around the vehicle.

A vehicle surrounding image display device includes a display control unit is configured to cause an image display unit to display a first image in a specific area, the first image being one of captured images and corresponding to the specific area, the captured images being generated by a capturing unit by capturing an area behind a vehicle and an area behind and to sides of the vehicle, the specific area being an area within a range of a first length extending in both directions outward from a horizontal central part of a display area of the image display unit and within a range of a second length extending vertically downward from an upper end of the display area; and cause the image display unit to display a second image in an area outside of the specific area of the display area, the second image being one of the captured images and corresponding to the area outside of the specific area, the second image being compressed higher than the first image.

According to the aspect described above, the area included in the display area of the image display unit and corresponding to an object that is located at a relatively large distance from the vehicle is set as the specific area. In addition, the second image corresponding to an object that is located at a relatively small distance from the vehicle and displayed outside of the specific area is compressed higher than the first image displayed in the specific area. In this way, the vehicle surrounding image display device according to the aspect described above switches the display of images between the two areas, the specific area and the area outside of the specific area, where the distance between the vehicle and an object differs between these two areas, allowing an occupant to feel a more correct sense of distance to an object around the vehicle.

In the aspect described above, the first image may be an image captured in a capturing range located at a predetermined distance or more from the vehicle; and the second image may be an image captured in a capturing range within the predetermined distance from the vehicle.

According to the configuration described above, since the capturing range of the first image displayed in the specific area is a range that is located at the predetermined distance or more from the vehicle, an occupant can feel a sense of distance to an object that is the predetermined distance or more from the vehicle. In addition, according to the configuration described above, since the capturing range of the second image displayed outside of the specific area is a range that is within the predetermined distance from the vehicle, an occupant can feel a sense of distance to an object that is less than the predetermined distance from the vehicle.

In the aspect described above, a compression ratio of the second image may be increased as a distance from a boundary of the specific area is increased.

According to the configuration described above, as compared with the case in which the compression ratio of the second image is not increased, the images in a wider capturing range can be displayed on the image display unit.

In the aspect described above, the display control unit may be configured to cause the image display unit to display the first image in such a way that the first image is displayed at a compression-decompression ratio corresponding to a size of an optical reflection image behind the vehicle and behind and to the sides of the vehicle which is visually recognized by an occupant of the vehicle, the optical reflection image being an image reflected on an optical inner rearview mirror of the vehicle.

According to the configuration described above, the first image can be displayed so that an occupant can feel a more correct sense of distance to an object included in the first image.

In the aspect described above, the display control unit may include a simulated image generation unit configured to generate a simulated image simulating a body of the vehicle and a superimposed-image display unit configured to cause the image display unit to display the simulated image, which is generated by the simulated image generation unit, by superimposing the simulated image on the first image and the second image.

According to the configuration described above, the positional relationship between the images of objects, which are included in the first image and the second image, and the body of the vehicle, which is included in the simulated image, allows an occupant to feel a more correct sense of distance to the objects included in the first image and the second image.

The present disclosure has an effect that an occupant can feel a correct sense of distance to an object around a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a vehicle surrounding image display system;

FIG. 2 is an image diagram showing the capturing range of a camera in a configuration where one camera is provided;

FIG. 3 is a functional block diagram of a display ECU;

FIG. 4 is a diagram showing an example of a compression ratio map;

FIG. 5 is a flowchart showing display processing;

FIG. 6 is an image diagram showing an example of a captured image;

FIG. 7 is an image diagram showing an example of an image having a converted compression ratio;

FIG. 8 is an image diagram showing an example of an image displayed on a display;

FIG. 9 is a block diagram showing another example of a schematic configuration of the vehicle surrounding image display system; and

FIG. 10 is an image diagram showing the capturing range of cameras in a configuration in which three cameras are provided.

### DETAILED DESCRIPTION OF EMBODIMENTS

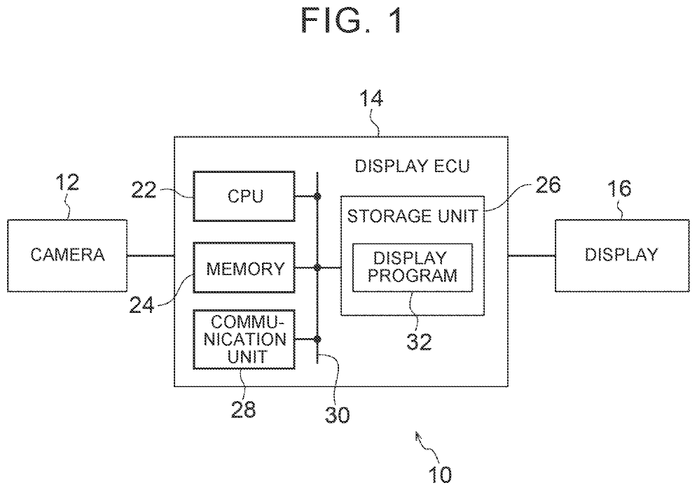

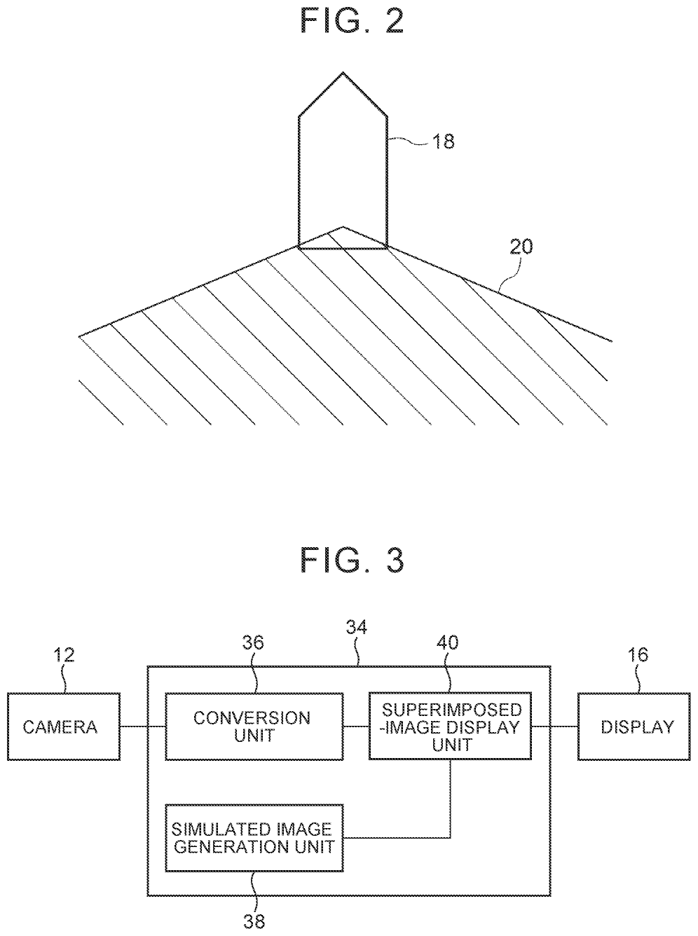

An example of an embodiment of the present disclosure will be described in detail below with reference to the drawings. A vehicle surrounding image display system 10 shown in FIG. 1 includes one camera 12, a display electronic control unit (ECU) 14, and a display 16. The camera 12 and the display 16 are connected to the display ECU 14. As shown in FIG. 2, the camera 12, with a relatively wide capturing range (capturing range 20), is attached to the rear of a vehicle 18 so that the image behind the vehicle 18 and behind and to the sides of the vehicle 18 can be captured. The camera 12 is an example of a capturing unit.

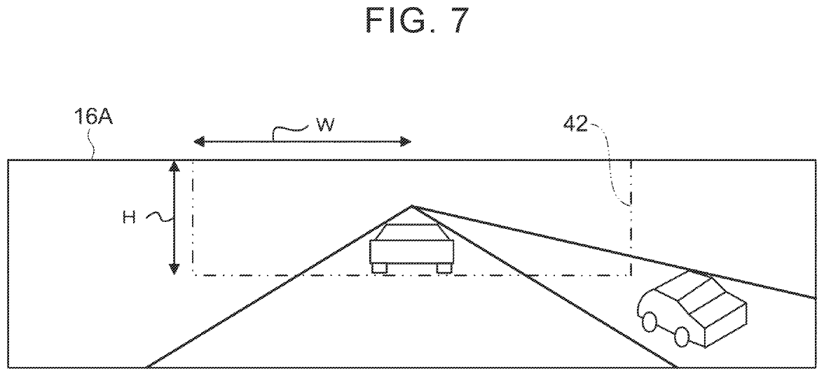

The display 16 is provided at a position spaced above the central part of the instrument panel of the vehicle 18 in the upward direction of the vehicle 18. As an example, a specific area 42 is set in the display area 16A of the display 16 as shown in FIG. 7. The specific area is an area within a range of the first length W extending in both directions outward from the horizontal central part of the display area 16A and within a range of the second length H extending vertically downward from the upper end of the display area 16A. In a vehicle provided with an optical inner rear-view mirror, the specific area 42 corresponds to an area where the image of an object from a predetermined distance L (for example, 5 m, 10 m, 15 m etc.) to an infinite distance away from the vehicle is displayed. The display 16 is an example of an image display unit.

The display ECU 14 includes a central processing unit (CPU) 22, a memory 24 such as a read only memory (ROM) and a random access memory (RAM), a nonvolatile storage unit 26 such as a hard disk drive (HDD) and a solid state drive (SSD), and a communication unit 28. The CPU 22, the memory 24, the storage unit 26, and the communication unit 28 are communicatively connected to each other via an internal bus 30.

The storage unit 26 of the display ECU 14 stores a display program 32. The display program 32 is read from the storage unit 26 and loaded into the memory 24. When the display program 32, loaded into the memory 24, is executed by the CPU 22, the display ECU 14 functions as a display control unit 34 that includes three functional units shown in FIG. 3: a conversion unit 36, a simulated image generation unit 38, and a superimposed-image display unit 40. These functional units perform the display processing that will be described below. The display ECU 14 is an example of a vehicle surrounding image display device.

The display control unit 34 causes the display 16 to display a first image in the specific area 42 that is an area in a display area 16A of the display 16. The first image is an image included in the images captured by the camera 12 and corresponding to the specific area 42. The first image is an image captured in the capturing range that is located at a predetermined distance L or more from the vehicle 18 (an image in the range from the predetermined distance L to the infinite distance) and is the image of an object that is at a position that is a predetermined distance L or more from the vehicle 18. In this embodiment, the capturing range of the first image, which is located at a predetermined distance L or more from the vehicle 18, is the range directly behind the vehicle and within a specific angle.

In addition, the display control unit 34 causes the display 16 to display a second image in an area outside of the specific area 42 of the display area 16A of the display 16 as an image compressed higher than the first image. The second image is an image included in the captured images and corresponding to an area outside of the specific area 42. The second image is an image captured in the capturing range that is less than a predetermined distance L from the vehicle 18 and is the image of an object that is at a position less than a predetermined distance L from the vehicle 18. In this embodiment, the capturing range of the second image, which is less than a predetermined distance L from the vehicle 18, is the range directly behind the vehicle and outside a specific angle.

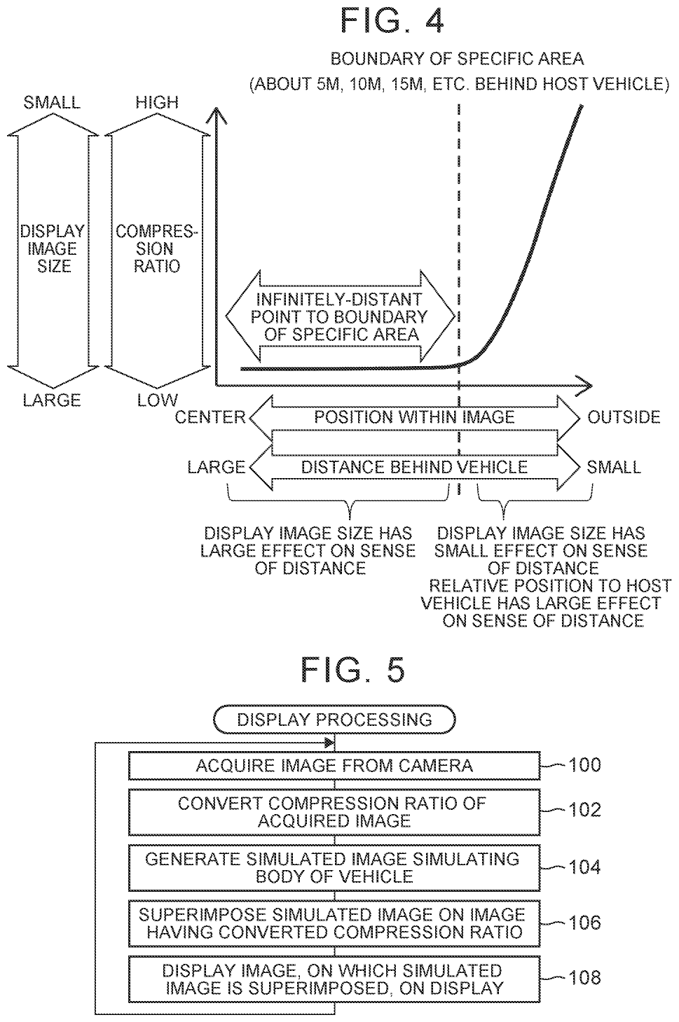

More specifically, the conversion unit 36 of the display control unit 34 compresses the second image higher than the first image as described above. For example, as shown in FIG. 4, the conversion unit 36 compresses the first image and the second image of the captured images based on the compression ratio map that defines the relationship between a position within an image and the compression ratio of the image at that position.

In the compression ratio map shown in FIG. 4, the compression ratio of the specific area 42 (compression ratio for the first image) is set to be substantially constant. The compression ratio of the specific area 42 is set in such a way that the first image displayed in the specific area 42 is displayed at a compression ratio corresponding to the size of the optical reflection image behind the vehicle and behind and to the sides of the vehicle which is visually recognized by an occupant of the vehicle. The optical reflection image is an image reflected on the optical inner rearview mirror of the vehicle. On the other hand, in the compression ratio map shown in FIG. 4, the compression ratio of the area outside of the specific area 42 is set in such a way that the compression ratio of the area of outside of the specific area 42 (compression ratio for the second image) is increased as the distance from the boundary of the specific area is increased.

The simulated image generation unit 38 generates a simulated image simulating the body of the vehicle 18 that comes into view when an occupant views the area behind the vehicle 18 and behind and to the sides of the vehicle 18 from within the vehicle cabin of the vehicle 18. The superimposed-image display unit 40 superimposes the simulated image, generated by the simulated image generation unit 38, on the first image and the second image and causes the display 16 to display the resulting image.

Next, an operation of this embodiment will be described below. More specifically, the display processing performed by the display ECU 14 while the ignition switch of the vehicle 18 is turned on will be described with reference to FIG. 5.

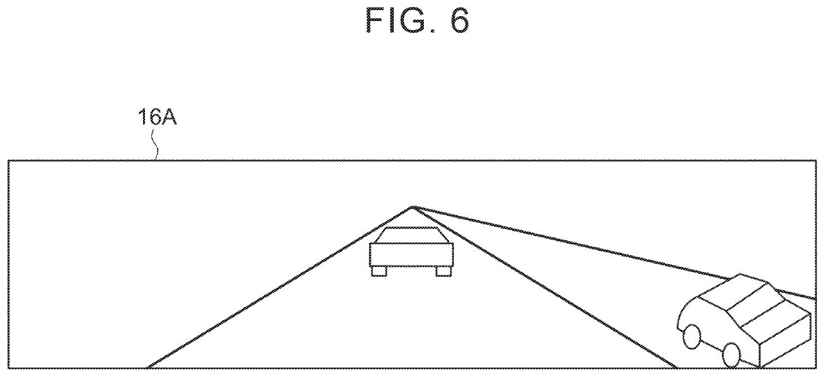

In step 100 of the display processing, the conversion unit 36 acquires a captured image, captured by the camera 12, from the camera 12. FIG. 6 shows an example of a captured image the conversion unit 36 acquires from the camera 12.

In step 102, the conversion unit 36 converts the compression ratio of the captured image, acquired from the camera 12, according to the compression ratio map (FIG. 4). FIG. 7 shows an example of an image having a compression ratio converted by the conversion unit 36. The comparison between FIG. 7 and FIG. 6 clearly indicates that, in the image where the compression ratio has been converted, the size of the image of the object displayed in the specific area 42 is the same while the size of the image outside of the specific area 42 is reduced (compressed).

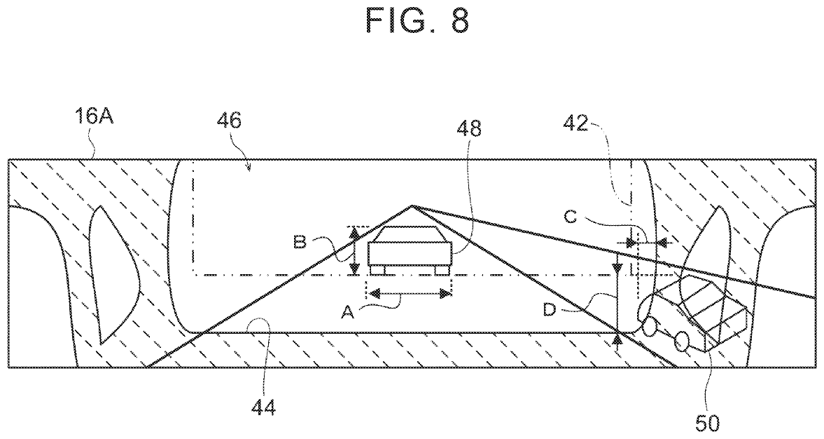

In step 104, the simulated image generation unit 38 generates a simulated image simulating the body of the vehicle 18. The simulated image, generated by the simulated image generation unit 38, is an image compressed according to the compression ratio map (FIG. 4). FIG. 8 shows an example of a simulated image, generated by the simulated image generation unit 38, as a simulated image 44. The simulated image 44 is an image in which the area corresponding to the body of the vehicle 18 is semitransparent (shaded area in the figure) and in which the area corresponding to the window of the vehicle 18 is transparent.

Note that a simulated image need not always be compressed in the same manner as the second image is compressed according to the compression ratio map. Instead, to prevent an unnatural distortion from being generated in a simulated image, only the image close to a window frame in the simulated image may be changed according to the scenery (second image).

In step 106, the superimposed-image display unit 40 superimposes the simulated image, generated by the simulated image generation unit 38, on the images having a compression ratio converted by the conversion unit 36 to generate a display image to be displayed by the display 16. In step 108, the superimposed-image display unit 40 causes the display 16 to display the display image generated in step 106.

As a result, an image such as a display image 46 shown in FIG. 8 is displayed in the display area 16A of the display 16. According to the knowledge obtained by the inventor of the present disclosure, for an object that is located at a predetermined distance L or more from the vehicle 18, the display size of the object on the display image 46 has a large effect on the feeling of a sense of distance to the object. Based on this knowledge, in the specific area 42 which is included in the display image 46 and in which an object that is located at a predetermined distance L or more from the vehicle 18 is displayed as an image, the compression ratio of the image is set lower than the compression ratio of an image outside of the specific area 42. As a result, the size of an image 48 displayed in the specific area 42 of the display image 46 (see arrows A and B in FIG. 8) allows an occupant of the vehicle to feel a correct sense of distance to an object corresponding to the image 48.

Furthermore, according to the knowledge obtained by the inventor of the present disclosure, for an object that is less than a predetermined distance L from the vehicle 18, the relative position between the vehicle and the object on the display image 46 has a large effect on the feeling of a sense of distance to the object. Based on this knowledge, in the outside of the specific area 42 which is included in the display image 46 and in which an object that is less than the predetermined distance L from the vehicle 18 is displayed as an image, the compression ratio of the image is set higher than the compression ratio of the specific area 42 and, therefore, the body of the vehicle 18 displayed in a larger part of this area as the simulated image 44. As a result, the relative position (see arrows C and D in FIG. 8) between the body of the vehicle 18, represented by the simulated image 44, and the image 50, displayed outside of the specific area 42 of the display image 46, allows an occupant of the vehicle to feel a correct sense of distance to the object corresponding to the image 50.

After the processing in step 108, the processing returns to step 100 and, while the ignition switch of the vehicle 18 is turned on, steps 100 to 108 are repeated. While step 100 to step 108 are performed repeatedly, the video of the surroundings is displayed on the display 16 in which the positions and sizes of the images of objects, included in the display image 46, change according to a change in the relative position between the vehicle 18 and objects around the vehicle 18.

In this embodiment, the display control unit 34 causes the display 16 to display the first image in the specific area 42 as described above. The first image is an image included in the images captured by the camera 12 by capturing the area behind the vehicle 18 and behind and to the sides of the vehicle 18 and corresponding to the specific area 42. The specific area 42 is an area within a range of the first length W extending in both directions outward from the horizontal central part of the display area 16A of the display 16 and within a range of the second length H extending vertically downward from the upper end of the display area 16A. Furthermore, the display control unit 34 causes the display 16 to display the second image included in the captured images and corresponding to the outside of the specific area 42 in an area outside of the specific area 42 of the display area 16A as an image compressed higher than the first image. Displaying the first image and the second image as described above allows an occupant to feel a more correct sense of distance to an object around the vehicle.

In this embodiment, the first image is an image in the capturing range that is located at a predetermined distance L or more from the vehicle 18, and the second image is an image captured in the capturing range that is less than a predetermined distance L from the vehicle 18. Displaying the first image and the second image allows an occupant to feel a sense of distance to an object that is located at a predetermined distance L or more from the vehicle 18 and to feel a sense of distance to an object that is less than a predetermined distance L from the vehicle 18.

In this embodiment, the display control unit 34 increases the compression ratio of the second image as the distance from the boundary of the specific area 42 increases, causing the display 16 to display images in a wider capturing range.

In addition, in this embodiment, the display control unit 34 causes the display 16 to display the first image in such a way that the first image is displayed at a compression/decompression ratio corresponding to the size of the optical reflection image behind the vehicle and behind and to the sides of the vehicle which is visually recognized by the driver of the vehicle. The optical reflection image is an image reflected on the optical inner rearview mirror of the vehicle. Displaying the first image in this way allows an occupant to feel a more correct sense of distance to an object included in the first image as an image.

Furthermore, in this embodiment, the display control unit 34 includes the simulated image generation unit 38 that generates a simulated image simulating the body of the vehicle 18 and the superimposed-image display unit 40 that causes the display 16 to display the simulated image, generated by the simulated image generation unit 38, with the simulated image superimposed on the first image and the second image. This configuration allows an occupant to feel a more correct sense of distance to the objects included in the display image 46, based on the positional relationship between the images of objects included in the display image 46, such as the first image and the second image, and the body of the vehicle included in the simulated image.

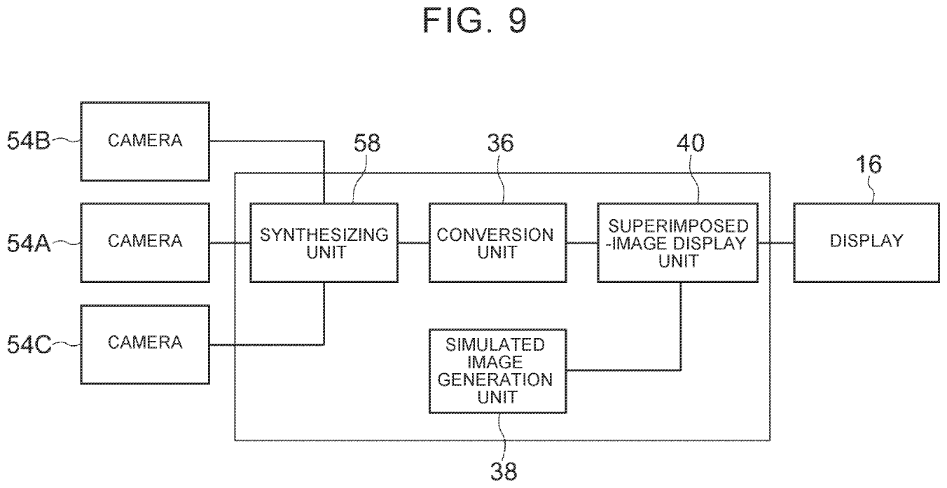

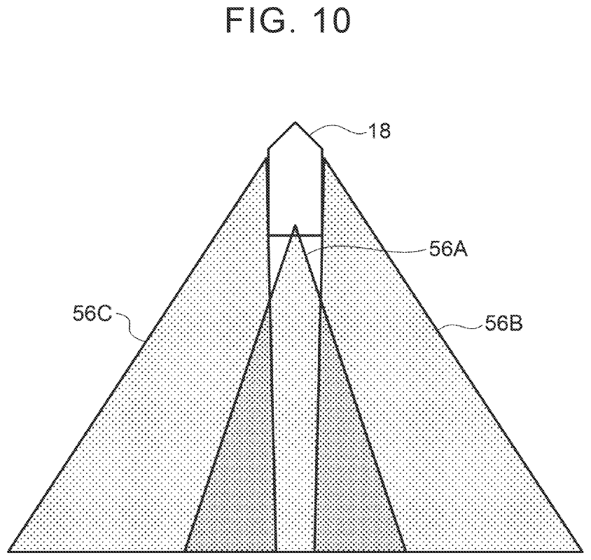

One camera, camera 12, is provided as the capturing unit in the configuration described above, while three cameras, cameras 54A to 54C, are provided as the capturing units in the configuration shown in FIG. 9. As shown in FIG. 10, the camera 54A captures the area behind the vehicle 18 from the rear of the vehicle 18 (capturing range 56A), the camera 54B captures the area to the right of the vehicle 18 and behind and to the right of the vehicle 18 from the right side of the vehicle 18 (capturing range 56B), and the camera 54C captures the area to the left of the vehicle 18 and behind and to the left of the vehicle 18 from the left side of the vehicle 18 (capturing range 56C). In FIG. 9, the display control unit 34 includes a synthesizing unit 58. The synthesizing unit 58 synthesizes the three captured images captured by three cameras, cameras 54A to 54C, into one image and outputs the synthesized image to the conversion unit 36. In this way, the capturing unit may be configured to include a plurality of cameras.

In the above description, the display 16 is provided at a position spaced above the central part of the instrument panel of the vehicle 18. However, the installation position of the display 16 is not limited to the position described above. For example, the display 16 may be provided at the central part of the instrument panel of the vehicle 18.

In the above description, the compression ratio of an area outside of the specific area 42 (compression ratio for the second image), defined in the compression ratio map shown in FIG. 4, is increased linearly as the distance from the boundary of the specific area is increased. However, the compression ratio is not limited to this definition. For example, the compression ratio of an area outside of the specific area 42 (compression ratio for the second image) may be increased curvilinearly (for example, quadratically) as the distance from the boundary of the specific area is increased.

What is claimed is:

1. A vehicle surrounding image display device comprising a display control unit configured to:
cause an image display unit to display a first image in a specific area, the first image being one of captured images and corresponding to the specific area, the captured images being generated by a capturing unit by capturing an area behind a vehicle and an area behind and to sides of the vehicle, the specific area being an area within a range of a first length extending in both directions outward from a horizontal central part of a display area of the image display unit and within a range of a second length extending vertically downward from an upper end of the display area; and
cause the image display unit to display a second image in an area outside of the specific area of the display area, the second image being one of the captured images and corresponding to the area outside of the specific area, the second image being compressed higher than the first image.

2. The vehicle surrounding image display device according to claim 1, wherein:
the first image is an image captured in a capturing range located at a predetermined distance or more from the vehicle; and
the second image is an image captured in a capturing range within the predetermined distance from the vehicle.

3. The vehicle surrounding image display device according to claim 1, wherein a compression ratio of the second image is increased as a distance from a boundary of the specific area is increased.

4. The vehicle surrounding image display device according to claim 1, wherein the display control unit is configured to cause the image display unit to display the first image in such a way that the first image is displayed at a compression-decompression ratio corresponding to a size of an optical reflection image behind the vehicle and behind and to the sides of the vehicle which is visually recognized by an occupant of the vehicle, the optical reflection image being an image reflected on an optical inner rearview mirror of the vehicle.

5. The vehicle surrounding image display device according to claim 1, wherein the display control unit includes:
a simulated image generation unit configured to generate a simulated image simulating a body of the vehicle; and
a superimposed-image display unit configured to cause the image display unit to display the simulated image by superimposing the simulated image on the first image and the second image, the simulated image being generated by the simulated image generation unit.
